(19) United States
(12) Patent Application Publication
(10) Pub. No.: US 2012/0021108 A1
(43) Pub. Date: Jan. 26, 2012

(54) Cold Brew System and Method for Making Cold Brew Coffee or Tea Extract

(75) Inventors: Scott Baumann, Anacortes, WA (US); Brian Wheeler, Bellingham, WA (US); Kim L. Alfreds, Blaine, WA (US)

(73) Assignee: Procreate Brands LLC, Ferndale, WA (US)

(21) Appl. No.: 13/187,504

(22) Filed: Jul. 20, 2011

Related U.S. Application Data
(60) Provisional application No. 61/366,151, filed on Jul. 20, 2010.

(51) Int. Cl. A47J 31/00; A23F 5/26

(52) U.S. Cl. 426/433; 99/323

(57) ABSTRACT

A cold brew apparatus and a method of making cold brew extract are disclosed. The cold brew apparatus includes a flexible brewing bag having an opening therein. Premeasured brewable ingredients (e.g., coffee grounds, coffee beans, tea leaves, etc.) are located in the brewing bag. The opening in the brewing bag is uncovered to allow a liquid (e.g., water) to be added to the brewable ingredients. The opening in the brewing bag is covered after the liquid has been added, and the brewable ingredients and the liquid are left to steep for a period of time (e.g., approximately 8-24 hours). After the period of time has elapsed, extract (e.g., coffee extract, tea extract, etc.) is poured out of the opening in the brewing bag.

### CROSS-REFERENCE TO RELATED APPLICATION

This application claims the benefit of U.S. Provisional Application No. 61/366,151, filed Jul. 20, 2010, which is incorporated herein by reference in its entirety.

### FIELD OF THE INVENTION

The present invention relates generally to coffee or tea brewing devices and methods for making coffee or tea extract.

### BACKGROUND OF THE INVENTION

In contrast to traditional hot brew coffee systems, cold brew coffee systems do not require heat. Instead, a mixture of coffee grounds and water are left to steep for about 8-24 hours. Then, the mixture is filtered to obtain drinkable coffee extract.

Cold brew coffee is less acidic and less oily than hot brew coffee. Hence, by cold brewing coffee, the bitterness and bite associated with hot brew coffee is reduced. For many consumers, the reduction of such bitterness and bite is desirable.

Despite its advantages relative to hot brewing, cold brewing is not a particularly popular technique for making coffee. One reason for its lack of popularity may be that prior cold brew coffee systems require a consumer to handle coffee beans and/or coffee grounds.

For example, in some cases, consumers are required to measure dry coffee grounds (or coffee beans) during the initial steps of the cold brew process. Then, once the cold brew process is complete, consumers are required to dispose of loose, soaked coffee grounds (or coffee beans).

Overall, any handling of coffee grounds and coffee beans is considered to be undesirable. In some cases, a consumer might find such handling to be cumbersome or messy.

Accordingly, it would be desirable to develop a cold brew coffee system that does not require a consumer to handle coffee grounds or coffee beans prior to brewing same.

Another reason for the lack of popularity of cold brew coffee may be because some cold brewing systems require parts to be assembled, replaced, cleaned and/or stored. When parts are required to be stored, they may be lost. Furthermore, when parts are assembled and disassembled, they may become worn or break.

Therefore, it would be desirable to develop a cold brew coffee system that is easy to use and requires no parts to be assembled, replaced, cleaned and/or stored. It would also be desirable to develop a cold brew coffee system that was self-contained and/or disposable.

### SUMMARY OF THE INVENTION

The present invention is designed to address at least one of the aforementioned problems and/or meet at least one of the aforementioned needs.

In one embodiment, a cold brew apparatus is disclosed. The cold brew apparatus includes a flexible brewing bag having an opening therein. Premeasured brewable ingredients (e.g., coffee grounds, coffee beans, tea leaves, etc.) are located in the brewing bag. The opening in the brewing bag is uncovered to allow a liquid (e.g., water) to be added to the brewable ingredients. The opening in the brewing bag is covered after the liquid has been added, and the brewable ingredients and the liquid are left to steep for a period of time (e.g., approximately 8-24 hours). After the period of time has elapsed, extract (e.g., coffee extract, tea extract, etc.) is poured out of the opening in the brewing bag.

Other objects, features, embodiments and advantages of the invention will be apparent from the following specification taken in conjunction with the following drawings.

### BRIEF DESCRIPTION OF DRAWINGS

FIG. 1 is a perspective view of a cold brew system in accordance with an exemplary embodiment of the present invention;

FIG. 2 is a perspective of the cold brew system of FIG. 1 illustrating a brewing bag, a filter bag positioned outside of the brewing bag and a cap removed from a spout;

FIG. 3 is a partial cutaway view of the cold brew system of FIG. 1 with a portion of a brewing bag and a portion of a filter bag removed and with a cap removed from a spout;

FIG. 4A is a sectional view of the cold brew system of FIG. 1 illustrating the interior of a brewing bag with no filter bag therein;

FIG. 4B is a magnified view of a portion of FIG. 4A;

FIG. 5 is a plan view of the cold brew system of FIG. 1;

FIG. 6A is first end view of the cold brew system of FIG. 1, wherein the system has yet to be filled with water but contains brewable ingredients;

FIG. 6B is second end view of the cold brew system of FIG. 1, wherein the system has yet to be filled with water but contains brewable ingredients;

FIG. 7A is a bottom view of the cold brew system of FIG. 1;

FIG. 7B is a top view of the cold brew system of FIG. 1;

FIGS. 8A-8D are various views of a diaphragm check valve;

FIG. 9 is a perspective view of a cold brew system in accordance with another exemplary embodiment of the present invention, wherein a heat seal dimple is provided;

FIG. 10 is a sectional view of the cold brew system of FIG. 9 illustrating possible routes along which extract may flow;

FIG. 11 is a sectional view of a cold brew system in accordance with yet another exemplary embodiment of the present invention, wherein a filter is integrated with a spout;

FIG. 12 is a perspective view of a cold brew system in accordance with yet a further exemplary embodiment of the present invention;

FIG. 13 is a schematic plan view of a cold brew system in accordance with another exemplary embodiment of the present invention;

FIG. 14 is a schematic plan view of the cold brew system of FIG. 13, wherein a check valve has been removed from the brewing bag;

FIG. 15 is a sectional view taken along line 3-3 of FIG. 14, which shows a resealable closure an open configuration;

FIG. 16 is a sectional view taken along line 3-3 of FIG. 14, which shows a resealable closure in a closed configuration;

FIG. 17 is a schematic plan view of a cold brew system of yet another embodiment of the present invention, which is used to illustrate exemplary configurations of filter bags that are integrated with the brewing bag in the manufacturing process, so as to prevent the filter bag from interfering with the output through the spout;

FIG. 18 is a cross-sectional view taken along line 6-6 of FIG. 17 illustrating a first exemplary configuration of a filter bag that is integrated with a brewing bag;

FIG. 19 is a cross-sectional view taken along line 6-6 of FIG. 17 illustrating a second exemplary configuration of a filter bag that is integrated with a brewing bag;

FIG. 20 is a cross-sectional view taken along line 6-6 of FIG. 17 illustrating another exemplary configuration of a filter bag and a brewing bag;

FIG. 21 is a perspective view of a cold brew system of yet another embodiment of the present invention;

FIG. 22 is a side view of an exemplary arrangement for producing large volumes of extract using a cold brew system, wherein the arrangement includes a rack and a container for receiving cold brewed extract;

FIG. 23 is a top view of the embodiment shown in FIG. 22;

FIG. 24 is a side view of another exemplary arrangement for producing large volumes of extract using a plurality of cold brew systems, wherein the arrangement includes a multi-shelved rack and a plurality of containers for receiving cold brewed extract; and,

FIG. 25 is a top view of the embodiment shown in FIG. 23.

### DETAILED DESCRIPTION

The present invention is directed to a cold brew coffee system and a method for making cold brew coffee.

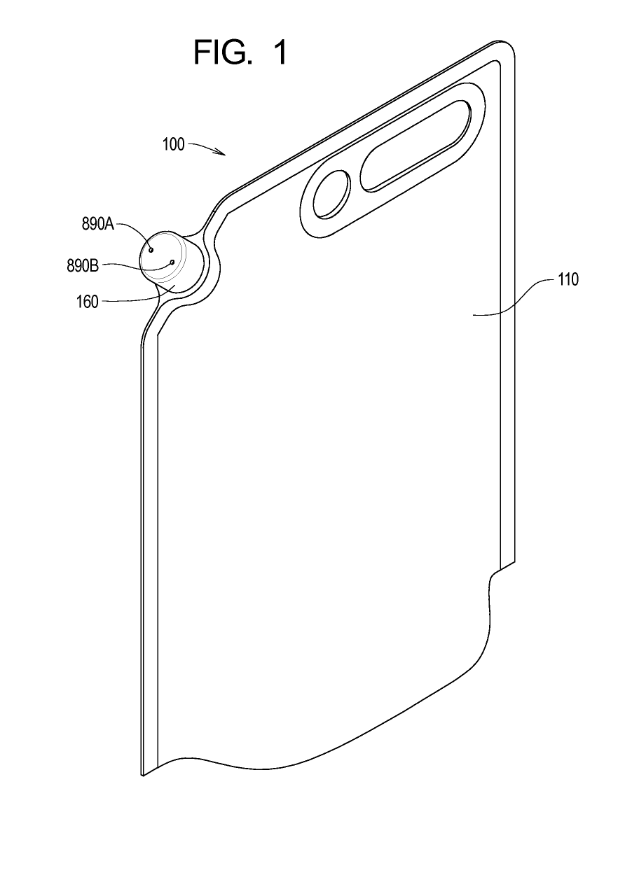

An exemplary embodiment of a cold brew system 100 is illustrated in FIGS. 1-3. The exemplary embodiment of the cold brew system 100 is self-contained and disposable, although other embodiments are possible.

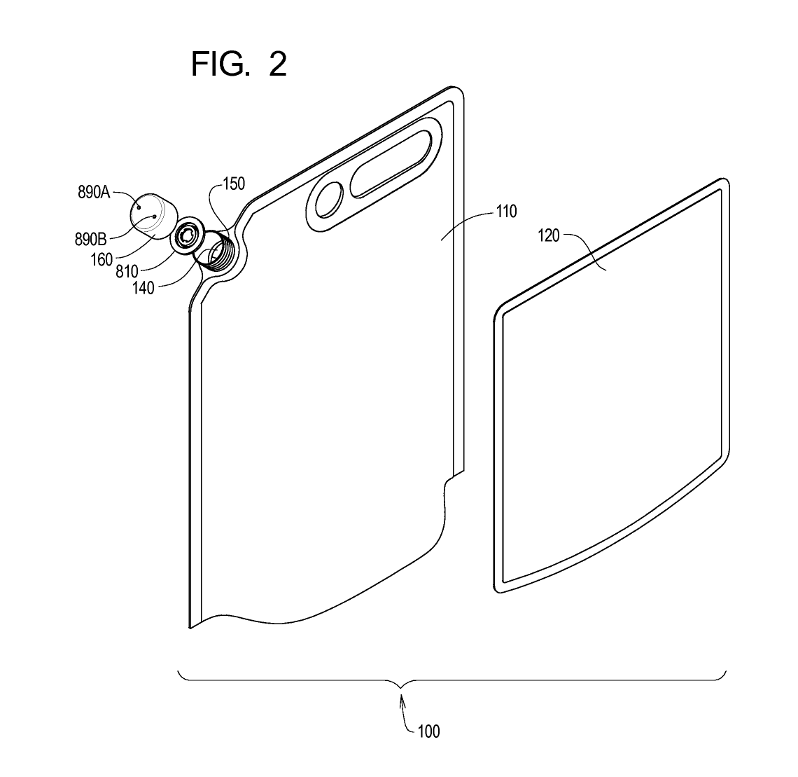

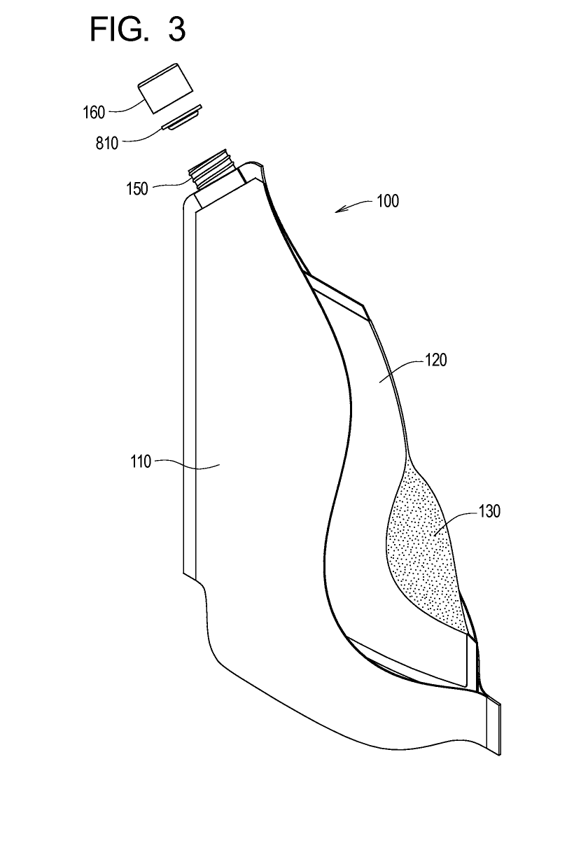

With reference to FIGS. 2 and 3, the cold brew system 100 includes a brewing bag 110 and a filter bag 120. The filter bag 120 is located inside of the brewing bag 110 and, as shown in FIG. 3, has brewable ingredients 130 therein. Among other things, the brewable ingredients may include coffee grounds, coffee beans, tea leaves, tea fannings, cacao beans, cacao grounds and/or a mixture of two or more of the above. In one embodiment, the brewable ingredients 130 are premeasured prior to purchase by a user, so that a user does not have to measure or handle them.

In one embodiment, the filter bag 120 may also include other items in addition to the aforementioned brewable ingredients. For example, the filter bag 120 may include other ingredients therein, such as sweeteners (e.g., sugar (raw and/or refined), sugar substitutes, honey, flavored syrups, etc.), spices (e.g., cinnamon, nutmeg, pumpkin spice, cloves, vanilla extract, vanilla bean, cocoa, cardamom, etc.), diary-based products (e.g., powdered milk, creamer, half-and-half, etc.) and other constituents (e.g., marshmallows, chocolate, caramel, peppermint, candy, chicory, fennel seed, etc.).

As shown in FIG. 2, the brewing bag 110 includes an opening 140 therein into which a liquid (or liquids) may be poured. The filter bag 120 is porous and allows liquids to be received therein, so as to permit the brewable ingredients 130 in the filter bag 120 to become saturated. When cold brewing coffee, water may be received in the porous filter bag 120, although other liquids are possible and anticipated.

In one embodiment, the amount of liquid to be added is based upon the amount of brewable ingredients 130 in the filter bag (e.g., nine cups of water to one pound of coffee, although other ratios are possible and anticipated). In one embodiment, the brewing bag 110 is sized to receive an amount of water that corresponds to the amount of brewable ingredients 130 in the filter bag 120. That is, in one embodiment, the amount of liquid required to completely fill the brewing bag 110 (or to fill it to a predefined point) corresponds to the amount of liquid required for the brewable ingredients 130 in the filter bag 120. In other words, the cold brew system 100 is scalable. In one embodiment, a portion of the brewing bag 110 is transparent or semi-transparent and includes a fill line (not shown), which corresponds to the appropriate amount of liquid required for the brewable ingredients 130 in the filter bag 120.

In one embodiment, a brewing bag has one pound of brewable ingredients therein and is 10 inches by 12 inches by 4 inches. In one embodiment, a brewing bag has one-half pound of brewable ingredients therein and is 5 inches by 6 inches by 2 inches. In one embodiment, the brewing bag has five pounds of brewable ingredients therein and is sized to receive fourteen quarts of water. It should be noted that other brewing bag sizes are possible and anticipated, including different ratios in width, height and depth.

In one embodiment, the opening 140 is in a spout 150 that is attached to the brewing bag 110. In one embodiment, a cap 160 is removed prior to pouring the liquid into the opening 140 in the spout 150. After the liquid has been poured into the brewing bag 110, the cap 160 is placed over the opening. Next, the mixture of brewable ingredients and liquid is left to steep for 8-24 hours in the airtight brewing bag 110.

Subsequently, the cap 160 is removed and extract (e.g., coffee extract or tea extract) is poured out of the spout 150 into a carafe or some other container (not shown), which may contain a single-shot dispensing mechanism (e.g., a 1 ounce dispensing mechanism, although other volumes are possible and anticipated).

One reason for pouring the extract out of the brewing bag 110 is to avoid over-brewing or over-steeping. However, in one embodiment, instead of pouring the extract into a container, it may be dispensed directly out of the brewing bag 110. In such case, in one embodiment, the cap 160 may include a dispensing mechanism. In one embodiment, a dispensing mechanism is located at a position that is different from the position of the cap 160.

Advantageously, because the filter bag 120 has a large surface area through which extract may travel, the filter bag 120 does not get clogged by particulates (e.g., coffee particulates), which allows the extract to be poured out of the spout 150 relatively quickly. In one embodiment, the surface area of the filter bag 120 is approximately the same as the surface area of the brewing bag 110. In one embodiment, the surface area of the filter bag 120 is at least one-half the surface area of the brewing bag 110.

In one embodiment, the brewing bag 110 has a plurality of filter bags 120 located therein, wherein the plurality of filter bags have brewable ingredients therein. In one embodiment, the combined surface area of the plurality of filter bags is greater than the surface area of the brewing bag.

In one embodiment, the filter bag 120 in its empty state is substantially the same size as the brewing bag 110 in its empty state. In one embodiment, the filter bag 120 in its empty state is greater than half the size as the brewing bag 110 in its empty state. In one embodiment, multiple filter bags are provided and the aggregate size of the filter bags when laid next to one another in their empty state is greater than half the size of the brewing bag in its empty state.

In one embodiment, the filter bag 120 is flexible. It should be noted that the filter bag 120, in some embodiments, may be made of a variety of natural and/or synthetic fibers. In one embodiment, the filter bag 120 may be made of a polypropylene mesh, a nylon mesh, a felt microfiber, a heat sealable filter paper or a non-heat sealable filter paper. In one embodiment, the filter bag is made of any material or materials that are capable of retaining substantially all particulates of the brewable ingredients therein. Accordingly, the filter bag 120 may have a mesh size that is designed to filter appropriate particles. Of course, the filter bag may be made of many other materials and may have many other mesh sizes.

In one embodiment, the heat sealable filter paper may be made with a variety of natural and synthetic fiber combinations. For example, one or more filtration layers may be made from abaca fibers, wood pulp and/or cellulose rayon fibers. Furthermore, one or more sealing layers may be made from polyethylene mixed with copolymers, polypropylene mixed with copolymers and/or 100% polypropylene.

In one embodiment, non-heat sealable filter paper is typically produced with natural paper fibers. In one embodiment, such non-heat sealable filter paper may be “crimped” at the seams to form a mechanical bond.

In one embodiment, a filter bag system is provided (not shown), which includes an outer filter bag made of a relatively stronger and more durable material having a larger size mesh, and one or more inner filter bags, which may be less durable or have a smaller mesh size. In one embodiment, the outer filter bags are made of polypropylene and/or nylon, etc. In one embodiment, the inner filter bags are made of paper.

The brewing bag 110 may be made of a variety of materials in an assortment of configurations. For example, the brewing bag 110 may be made from polyester, nylon, polypropylene, aluminum foil or polyethylene. Furthermore, the configurations of the brewing bag 110 may range from a single layer to 2-, 3- or 4-ply (or more) laminated films.

In one embodiment, the brewing bag 110 is flexible and watertight. In one embodiment, the brewing bag 110 is made of a flexible plastic material. In one embodiment, the brewing bag 110 is made of a material commonly used for liquid pouches or beverage pouches.

In one embodiment, the brewing bag 110 is made of polyester, such as biaxially-oriented polyethylene terephthalate (“boPET”) (e.g., sold under the trade name Mylar), which is extremely durable and virtually unbreakable. In one embodiment, the brewing bag 110 is made of two layers of metalized PET and an inner layer of polyethylene.

When removing the extract from the cold brew system 100, the flow rate through the spout 150 may be increased by squeezing the brewing bag 110 (and, in some cases, correspondingly, the filter bag 120), since (in one embodiment) both the brewing bag 110 and the filter bag 120 are flexible.

In one embodiment, the brewing bag 110 and the filter bag 120 are not attached to one another. That is, the filter bag 120 can move relatively freely inside the brewing bag 110.

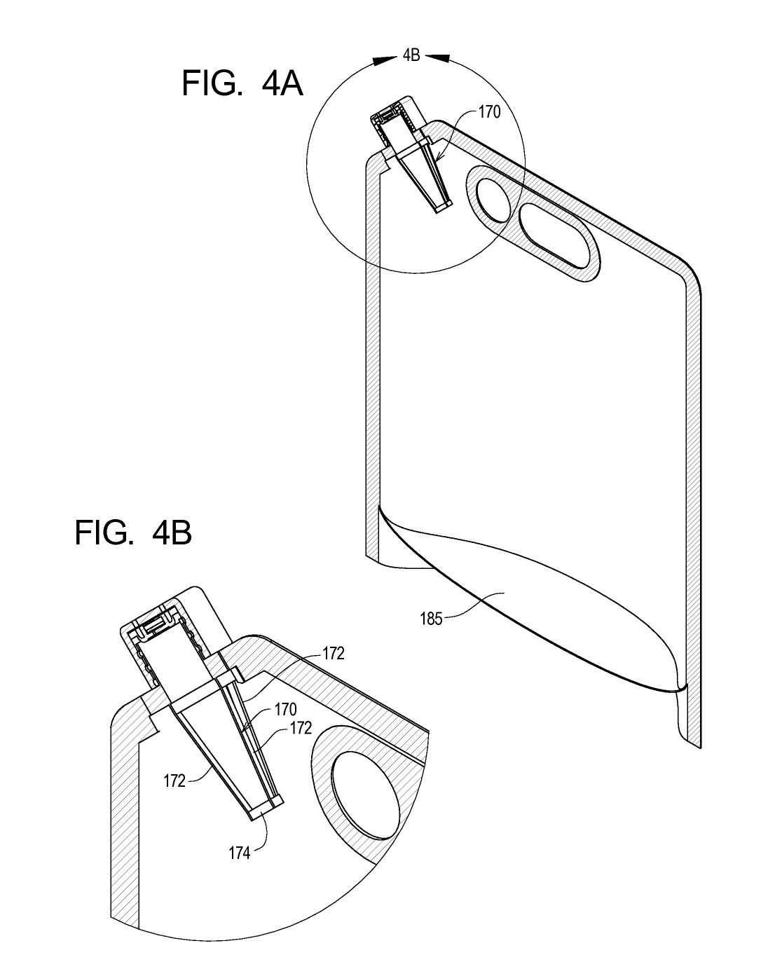

In one embodiment, the spout 150 includes a retaining member 170 (see FIGS. 4A and 4B) to provide clearance between the filter bag 120 and the opening 140 when pouring extract out of the brewing bag 110. Similarly, the retaining member 170 may also provide clearance between the filter bag 120 and the opening 140 when pouring liquid into the brewing bag 110. As shown in FIGS. 4A and 4B, the retaining member 170 may have a lattice-type (open) structure that includes a plurality of ribs 172 that are attached to a ring 174 (or, in some embodiments, a plurality of rings). Of course, there are a number of other ways to design the retaining member 170. Importantly, the retaining member 170 is designed to provide clearance as mentioned above.

In one embodiment, the brewing bag 110 and filter bag 120 are attached to one another. This may be advantageous in that, when the brewing bag 110 is turned upside down, so as to pour extract out of the brewing bag 110, the filter bag 120 is prevented from interfering with the opening 140. Furthermore, if a second opening is provided in the brewing bag 110 (e.g., near the bottom of the brewing bag 110), attachment of the filter bag 120 to the brewing bag 110 will prevent the filter bag from interfering with the second opening, even if the brewing bag is not turned upside down. For example, the filter bag 120 and brewing bag 110 can be attached such that there is some clearance between the second opening and the filter bag 120.

In order to attach the filter bag 120 to the brewing bag 110, the filter bag 120 may include straps (not shown) which are integral therewith. In one embodiment, the straps are heat sealed to the brewing bag 110 near the bottom thereof. In one embodiment, the straps are heat sealed near the top or along the sides (e.g., when a second opening is provided near the bottom of the brewing bag 110). Of course, in one embodiment, a second retaining member may be used to provide clearance between the filter bag 120 and the second opening.

In one embodiment, even though the filter bag 120 is attached to the brewing bag 110, the filter bag 120 still moves relative to the brewing bag 110. In one embodiment, the filter bag 120 is moveable relative to the brewing bag 110 in at least two dimensions. In one embodiment, the filter bag 120 includes an end that is attached to the brewing bag 110 and a free end. In one embodiment, the free end of the filter bag is moveable relative to the brewing bag in at least two dimensions.

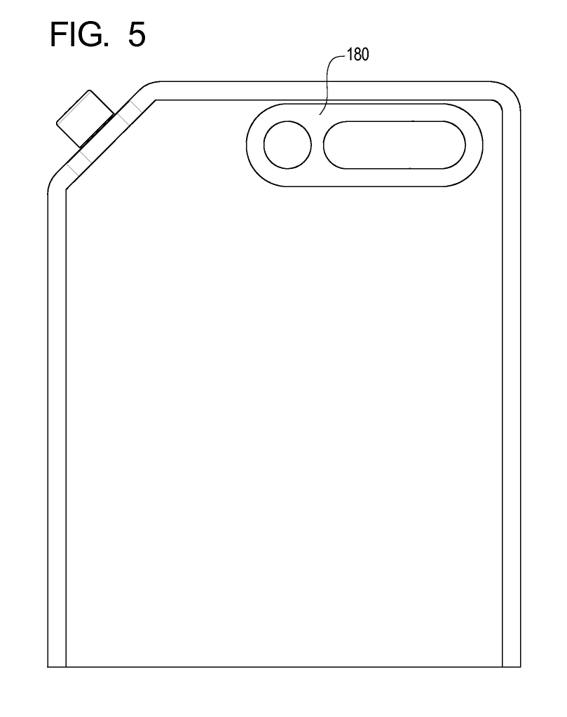

In one embodiment, with reference to FIG. 5, the brewing bag 110 includes a handle 180. As shown in FIG. 5, the handle 180 may include a small circular opening and a larger oval opening. It should be understood that other designs for the handle are possible and anticipated.

Returning to FIG. 4A, in one embodiment, a gusset 185 may be provided near the bottom of the brewing bag 110. The gusset 185 assists in keeping the brewing bag 110 in an upright configuration when the brewing bag does not have any liquid therein and after liquid has been added thereto.

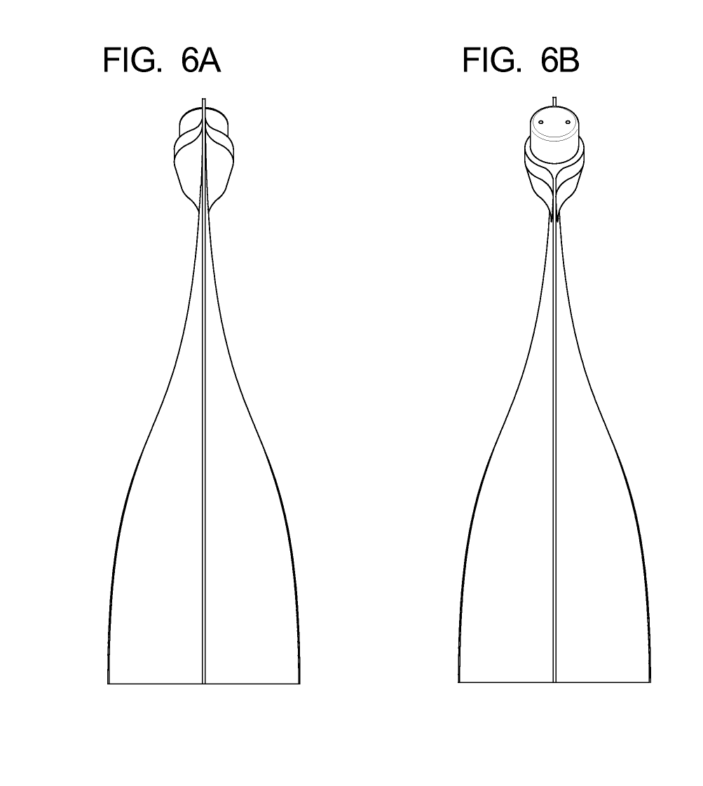

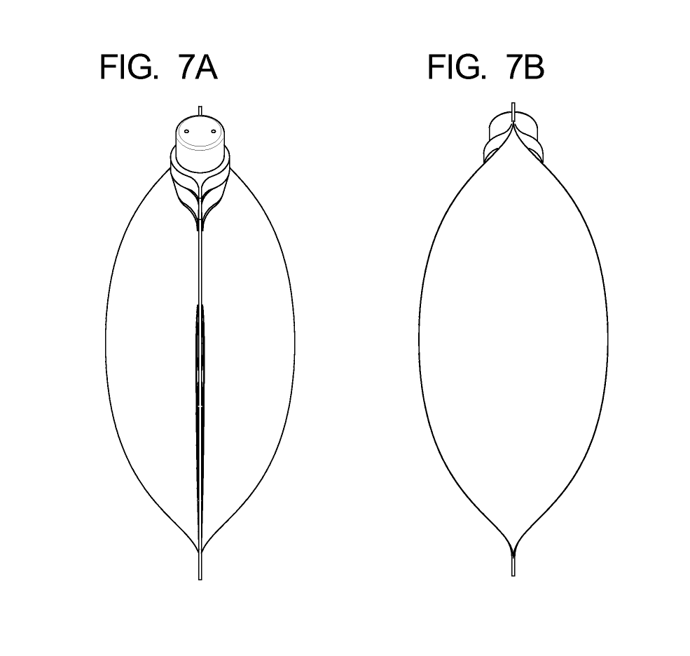

For completeness, other views of the exemplary embodiment of the cold brew system of FIG. 1 are briefly described. Specifically, FIG. 6A is first end view of the cold brew system of FIG. 1, wherein the system has yet to be filled with water but contains brewable ingredients. FIG. 6B is second end view of the cold brew system of FIG. 1, wherein the system has yet to be filled with water but contains brewable ingredients. Furthermore, FIG. 7A is a bottom view of the cold brew system of FIG. 1 and FIG. 7B is a top view of the cold brew system of FIG. 1.

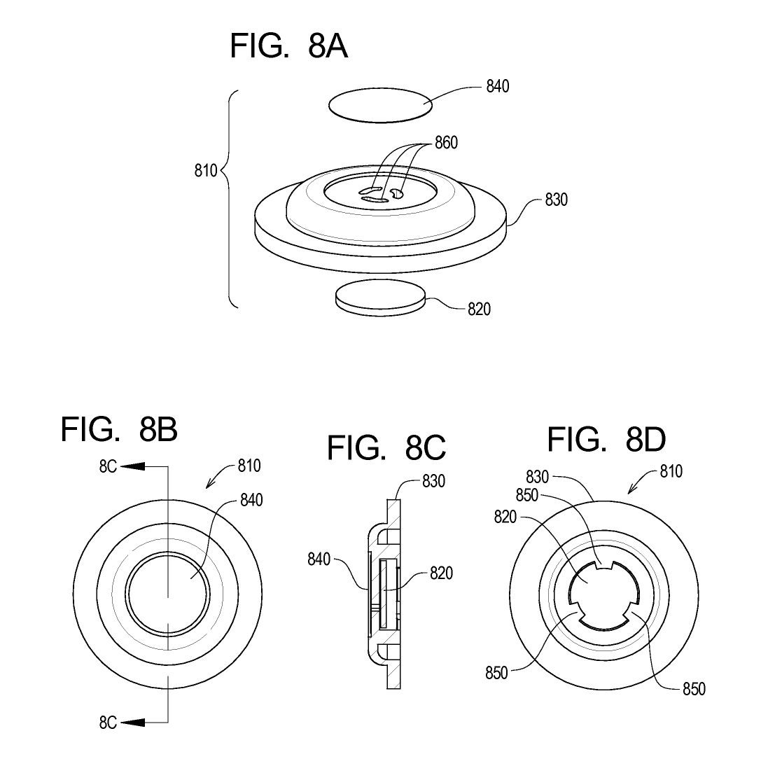

In some instances, gases may be released from roasted coffee grounds and/or roasted coffee beans. In order to permit some of such gases to be released from the brewing bag 110 (without allowing other gases to enter the brewing bag), in one embodiment, a check valve (i.e., one-way valve) is provided. An exemplary check valve 810 is shown in FIGS. 8A-8D.

FIGS. 8A-8D illustrate various views of a diaphragm check valve 810. FIG. 8A is an exploded view of the check valve 810 (wherein the bottom of the valve body is facing upwards), while FIG. 8B is a bottom view of the check valve 810. FIG. 8C is a cross-sectional view of the check valve 810 taken along line F-F, while FIG. 8D is a top view of the check valve 810.

As shown in FIGS. 8A-8D, the check valve includes a diaphragm 820, a valve body 830 and an optional filter 840. In one embodiment, the diaphragm 820 is flexible and made of rubber (or a similar material).

The diaphragm 820 is retained in the valve body 830 via a plurality of tabs 850. The valve body 830 also includes a plurality of holes 860 that pass completely therethrough, such that they would be viewable if the diaphragm 820 in FIG. 8D was removed.

The check valve 810 is normally closed with the diaphragm 820 being seated over the holes 860 in the valve body 830. When the pressure inside the brewing bag 110 is sufficient to unseat the diaphragm 820 from the valve body 830 (e.g., a gap is created between one or more of the holes 860 and the diaphragm 820, while the diaphragm 820 is retained by the tabs 850 of the valve body 830), gases are allowed to escape through the check valve 810 and are released outside the brewing bag 110. When the pressure inside the brewing bag 110 is reduced, the diaphragm 820 becomes seated over the holes 860 in the valve body 830 again and the valve 810 is closed.

When in use, the filter 840 is closest to the brewable ingredients 130 and the diaphragm 820 is furthest away from the brewable ingredients. Accordingly, the filter 840 ensures that the brewable ingredients don't clog or otherwise interfere with the holes 860 in the valve body 830.

In one embodiment, the check valve 810 is integrated with or connected to the cap 160. In one embodiment, the cap 160 includes apertures 890A, 890B (see FIG. 1) through which gases may escape.

In one embodiment, the check valve 810 is separate from the cap 160. In one embodiment, the check valve 810 is attached to the brewing bag 110. In one embodiment, the check valve 810 is located near the top of the brewing bag 110.

It is known to use check valves in retail packaging for roasted coffee. If attached to the brewing bag 100, the check valve 810 is similar to check valves used in retail packaging for roasted coffee.

In one embodiment, the check valve 810 (regardless of whether it is in the cap 160 or attached to the brewing bag 110) is used in conjunction with removing a volume of air from the brewing bag 110. In one embodiment, the check valve 810 is used to vacuum seal the brewable ingredients 130 in the brewing bag 110. Vacuum sealing is considered to be advantageous since it reduces the amount of air being shipped and because it allows the brewable ingredients to maintain their freshness (since exposing coffee grounds to air is known to generally degrade the quality of roasted coffee), so as to enhance the taste of the extract that is ultimately produced.

In one embodiment, a removable covering (not shown) is provided to seal the opening 140. The removable covering may be used to ensure that no one has tampered with the contents of the brewing bag 110. Other anti-tampering mechanisms may be used.

In one embodiment, the covering is made of foil. In one embodiment, the covering is made of boPET. In one embodiment, the covering is made of plastic. Of course, other materials may be used for the covering, as will be understood by those skilled in the art.

In one embodiment, a cap 160 is placed over the covered opening 140. In one embodiment, an anti-tampering mechanism may be associated with the cap 160 (even if only the cap 160 covers the opening), such as those mechanisms used for gallons of milk or other food and/or beverage packaging.

Instead of providing a single opening 140 into which water is poured and from which extract is removed, the brewing bag 110 may include a plurality of openings. In one embodiment, water (or some other liquid) is poured into the brewing bag 110 through one of the plurality of openings in order to soak the coffee. After the water and brewable ingredients have been left to steep for a period of time, extract is poured out of the brewing bag 110 through a different one of the plurality of openings.

In one embodiment, the brewing bag 110 acts as the retail packaging for the cold brew system. Accordingly, the brewing bag 110 includes appropriate indicia thereon (e.g., product name, trade name, universal product code, list of ingredients, nutritional information, etc.) to meet retail packaging requirements.

In one embodiment, the cold brew system 100 includes a rigid cover (not shown), such as a cardboard box or other container, in which the brewing bag 110 is located. In this embodiment, the rigid cover may act as the retail packaging for the cold brew system.

In one embodiment, at least some extract is not transferred to a dispensing container. Instead, the brewing bag 110 includes a valve (not shown) to dispense extract directly therefrom. In one embodiment, the valve is separate from the opening 140 in spout 150.

In one embodiment, as shown in FIGS. 2 and 5, the spout 150 is set an angle of approximately 45 degrees relative to vertical. In one embodiment, the spout 150 is set at a vertical angle, so as to allow water that is flowing straight down from a water tap to be poured directly into the opening 140 in the spout 150.

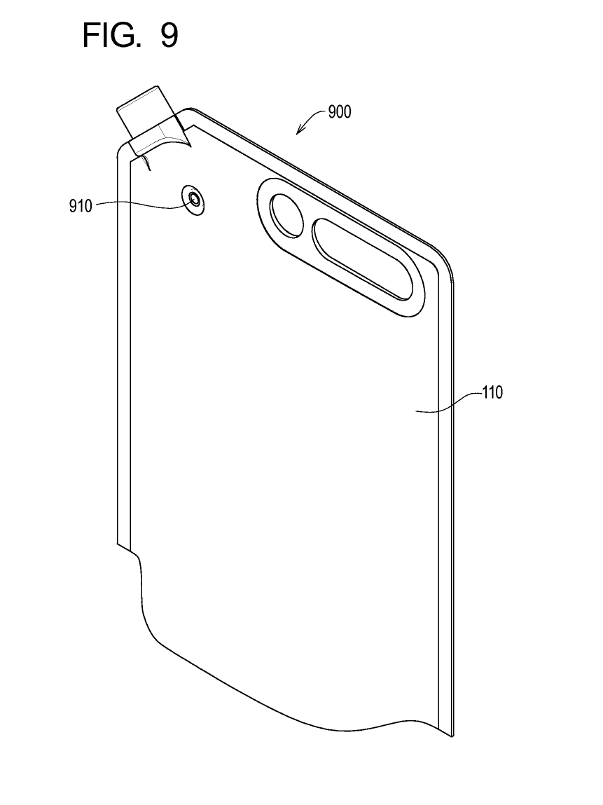

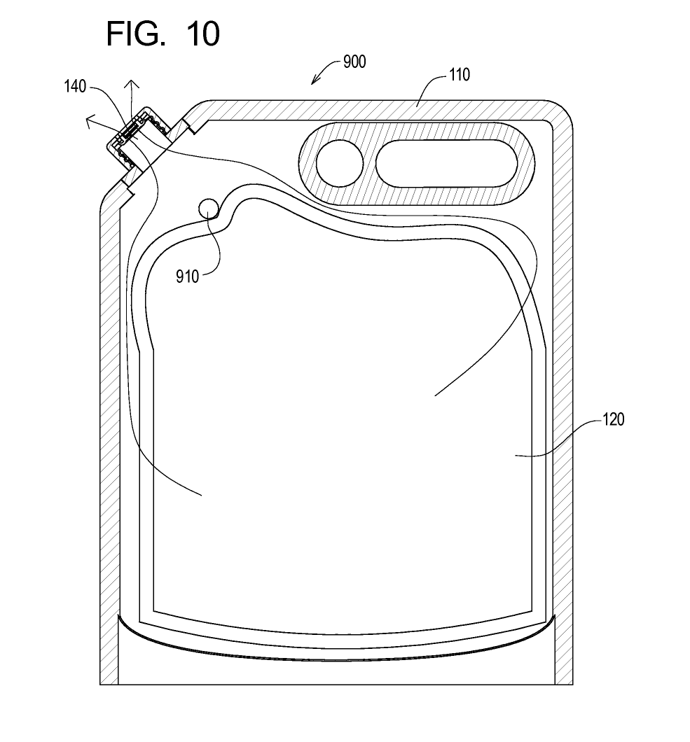

FIG. 9 is a perspective view of a cold brew system 900 in accordance with another exemplary embodiment of the present invention, while FIG. 10 is a sectional view of the cold brew system of FIG. 9. FIGS. 9 and 10 illustrate a heat seal dimple 910, which performs a similar function as the retaining member 170 shown in FIGS. 4A and 4B.

In one embodiment, heat seal dimple 910 is used to connect the front and the back of the brewing bag 110 together, so as to restrict movement of the filter bag 120. More specifically, heat seal dimple 910, provides clearance between filter bag 120 and the opening 140 when pouring extract out of the brewing bag 110 or when pouring liquid into the brewing bag 110. FIG. 10 illustrates a couple of possible paths (see arrows) that the extract may take when filter bag 120 has been retained by heat seal dimple 910.

It should be noted that, in one embodiment, multiple heat seal dimples may be provided. In one embodiment, other mechanisms for attaching the front and back of the brewing bag 110 together may be used, so as to provide clearance between the filter bag 120 and the opening 140. For example, one or more rivets (e.g., plastic rivets) may be provided.

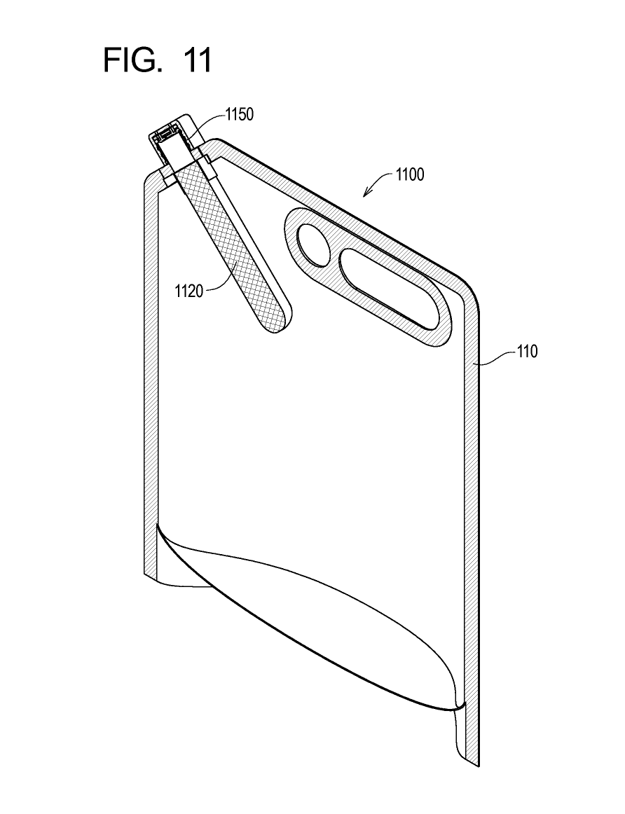

FIG. 11 is a sectional view of a cold brew system 1100 in accordance with yet another exemplary embodiment of the present invention. As shown in FIG. 11, the filter bag 120 has been replaced with (in some embodiments, it may be supplemented with) a filter 1120 that is integrated with (or adjacent to) a spout 1150. In one embodiment, the filter 1120 is made of a synthetic fiber type material.

In one embodiment, a separate opening (e.g., a fill opening with a cap) is provided to enable the brewing bag 110 to be filled with liquid. In one embodiment, no separate opening is provided. Instead, the brewing bag 110 is filled with liquid via the opening in spout 1150.

Filter 1120 is considered to be advantageous as compared to prior filters in that it has a larger surface area. It is believed that this will increase the flow rate through the opening in the spout 1150. Furthermore, by squeezing the brewing bag 110, the flow rate may be increased even more.

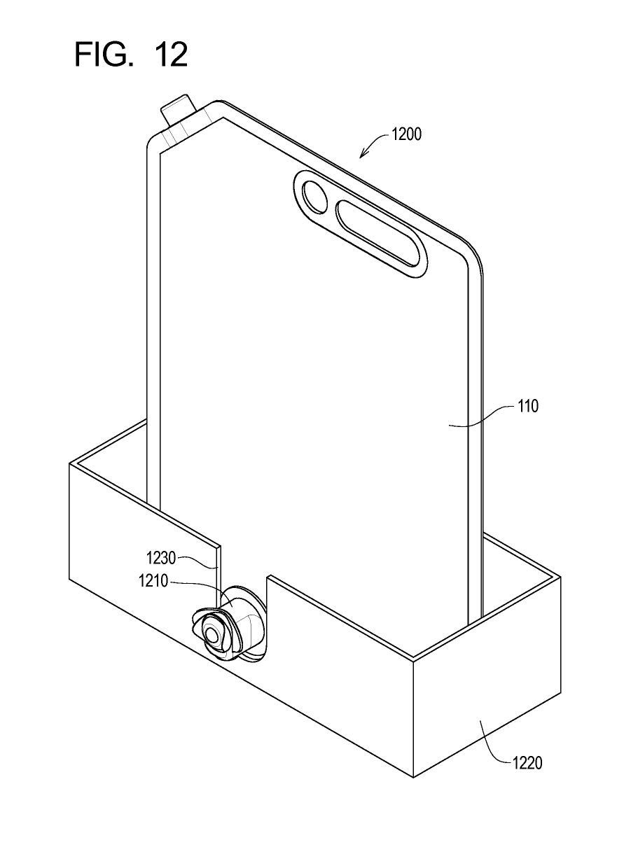

FIG. 12 is a perspective view of a cold brew system 1200 in accordance with yet a further exemplary embodiment of the present invention. The cold brew system 1200 is similar to the one shown in FIG. 1, except that it includes a drain valve 1210 and an optional base 1220. It should be noted that the drain valve 1210 (which provides access to a second opening in the brewing bag 110) may take a variety of forms and may include a handle or lever (among other things), instead of a push-button type system shown in FIG. 12.

The embodiment shown in FIG. 12 is intended to be used in commercial environments. Because larger amounts of brewable ingredients and, hence, larger amounts of liquid are likely to be used in commercial environments, two handles (not shown), instead of a single handle, may be provided. The base 1220 operates to stabilize the brewing bag 110. It may include a notch 1230 for receiving the drain valve 1210.

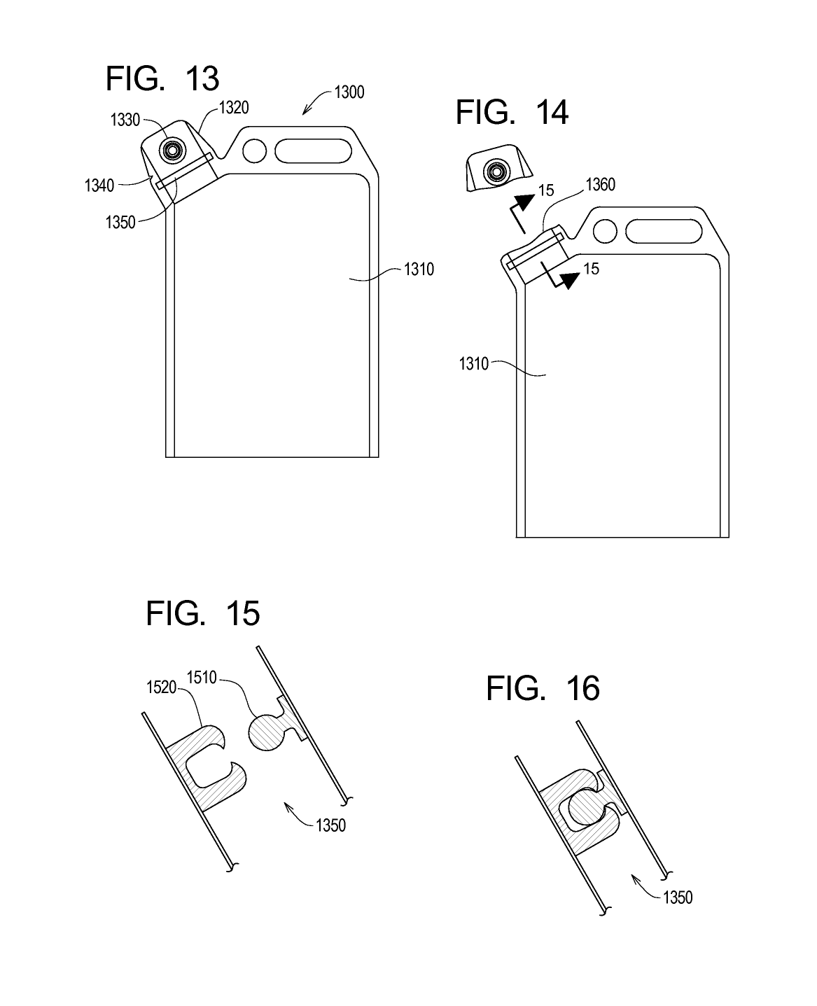

FIG. 13 is a schematic plan view of a cold brew system 1300 in accordance with another exemplary embodiment of the present invention. In contrast to the cold brew system shown in FIG. 1, no cap is provided.

The brewing bag 1310 includes an extended section 1320 that has a check valve 1330 (e.g., a one-way degassing valve), a notch 1340 and a resealable closure 1350. The brewing bag 1310 has brewable ingredients (e.g., in a filter bag) therein.

The check valve 1330 permits gases that may be released from the brewable ingredients (e.g., roasted coffee grounds and/or roasted coffee beans) to pass therethrough. Accordingly, the resealable closure 1350 is in an open configuration prior to liquid being added to the cold brew system 1300.

In order to brew the brewable ingredients, a user tears the extended section 1320 of the brewing bag 1310 along notch 1340, thereby removing the check valve 1330 and exposing an opening 1360 in the brewing bag 1310, as shown in FIG. 14. Next, an appropriate amount of liquid is added to the brewing bag 1310 via opening 1360. Once the liquid has been added, the resealable closure 1350 is sealed, so that the brewing bag 1310 becomes airtight.

Then, the mixture of brewable ingredients and liquid is left to steep. After a sufficient amount of time has passed, the resealable closure 1350 is opened and extract is poured out of the opening 1360 into a container.

One of the advantages of the cold brew system 1300 is that the check valve 1330 is not in fluid communication with the extract after liquid has been added to the brewable ingredients. Accordingly, extract cannot leak through the check valve 1330, regardless of the orientation of the cold brew system 1300.

In some cases in which a check valve is not removed, extract may leak through the check valve if the cold brew system is not maintained in a proper (e.g., upright) orientation. In one embodiment, this potential problem is solved by providing a sticker or some other cover, which is placed over the check valve or over apertures associated with the check valve (e.g., apertures 890A, 890B in cap 160 as shown in FIG. 1) after the brewing bag has been filled with liquid. In one embodiment, the aforementioned potential problem is solved by providing a second cap, which does not include apertures, that covers a spout after the brewing bag has been filled with liquid. In one embodiment, the aforementioned potential problem may be solved by providing a special cap, which has a venting position and a sealed position, such that the cap is in its venting position prior to adding liquid to the brewing bag and the cap is placed into its sealed position (e.g., by tightening it onto a spout) after adding liquid to the brewing bag.

FIG. 15 is a sectional view taken along line 3-3 of FIG. 14, which shows an exemplary resealable closure 1350 in an open configuration. FIG. 16 is a sectional view taken along line 3-3 of FIG. 15, which shows the exemplary resealable closure 1350 of FIG. 16 in a closed configuration. The exemplary resealable closure shown in FIGS. 15 and 16 is known as press-to-seal zipper strip and includes a male component 1510, which is received by a female component 1520. It should be understood that other types of resealable closures are possible and anticipated.

For example, in one embodiment, the resealable closure includes an adhesive, which is used to seal the resealable closure shut. In one embodiment, a second notch is provided under the resealable closure, so that the adhesive-based resealable closure is torn off, which then exposes an opening through which extract is poured. In one embodiment, the adhesive-based resealable closure may be cut off (e.g., with a pair of scissors).

In one embodiment, the resealable closure includes a foldable and rollable portion, which is used to seal the resealable closure shut. In one embodiment, a clamp is also provided to hold the foldable and rollable portion in place.

In one embodiment, a resealable closure may extend across the top, sides or bottom of the brewing bag (or may be in any other location, so as to provide a user access to the inside of the brewing bag). In such embodiment, once the brewable ingredients have been expended, one or more filter bags containing such expended brewable ingredients are removed from the brewing bag after opening the resealable closure. Then, one or more fresh filter bags (e.g., with premeasured brewable ingredients) are placed inside the brewing bag and the resealable closure is closed. (In one embodiment, liquid is added to the brewable ingredients prior to closing the resealable closure.) Accordingly, the brewing bag may be reused.

It should be understood that the resealable closure does not necessarily need to be resealable. That is, in some embodiments, the resealable closure is merely reopenable (e.g., capable of being closed once and then reopened once), but not capable of being resealed.

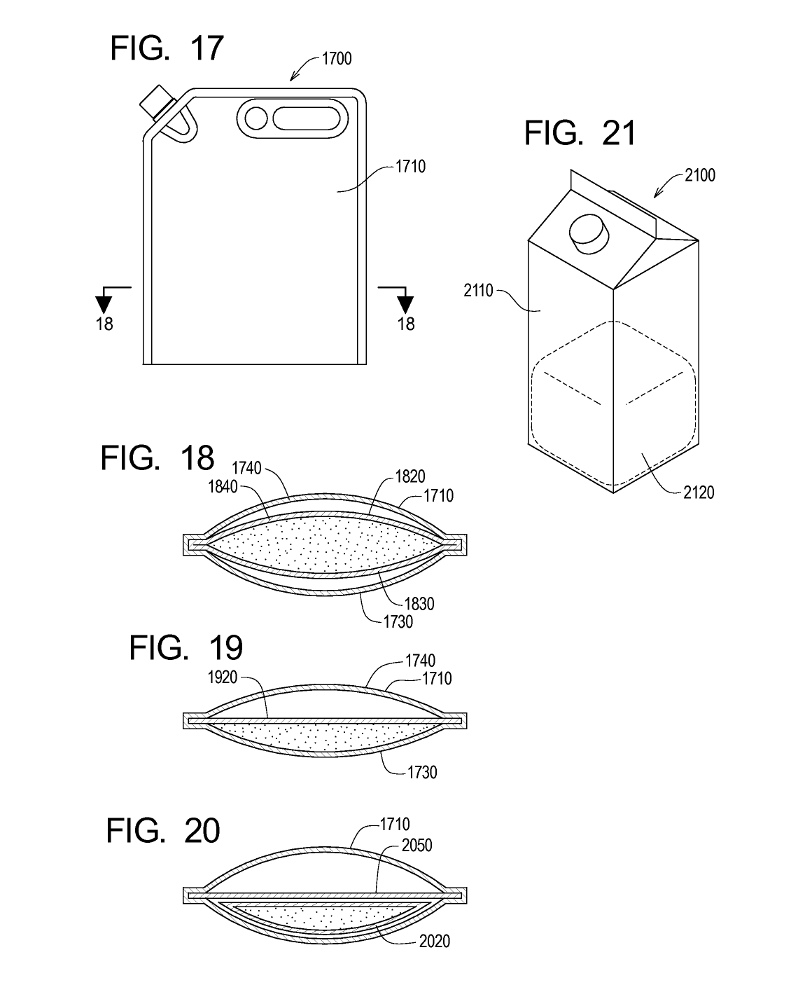

FIG. 17 is a schematic plan view of a cold brew system 1700 of yet another embodiment of the present invention. FIG. 17 is used to illustrate exemplary configurations of filter bags that are integrated with a brewing bag 1710 in the manufacturing process, so as to prevent the filter bag from interfering with the spout (or opening) when extract is being poured therethrough.

FIG. 18 is a cross-sectional view taken along line 6-6 of FIG. 17 and illustrates a first exemplary configuration of a filter bag 1820 that is integrated with a brewing bag 1710. The filter bag 1820 includes a front 1830 and a back 1840 between which brewable ingredients are placed. During manufacturing, the filter bag 1820 may be affixed to the brewing bag 1710, for example, by heat sealing along the edges of the brewing bag 1710 and the edges of the filter bag 1820. Of course, other techniques may be used to affix the brewing bag 1710 and filter bag 1820 to one another, and such techniques are anticipated.

FIG. 19 is a cross-sectional view taken along line 6-6 of FIG. 17 and illustrates a second exemplary configuration of a filter 1920 that is integrated with a brewing bag 1710. In this embodiment, brewable ingredients are placed between the filter 1920 and the front 1730 of the brewing bag 1710 (which together could be said to form a filter bag). In one embodiment, extract is poured through an opening in the brewing bag 1710 which is separate from the brewable ingredients (e.g., it is located between the back 1740 of the brewing bag 1710 and the filter 1920).

FIG. 20 is a cross-sectional view taken along line 6-6 of FIG. 17 and illustrates another exemplary configuration of a cold brew system. In this embodiment, the filter bag 2020 is separated from a portion of the brewing bag 1710 by a wall 2050. In this embodiment, the wall 2050 is integrated with the brewing bag 1710.

FIG. 21 is a perspective view of a cold brew system 2100 of yet another embodiment of the present invention. The cold brew system 2100 includes a relatively rigid container 2110 (e.g., like a milk carton) that has a filter bag 2120 therein. The filter bag 2120 may be filled with brewable ingredients and may be attached to the bottom or sides of the container 2110, so as to prevent the filter bag 2120 from interfering with an opening in the container.

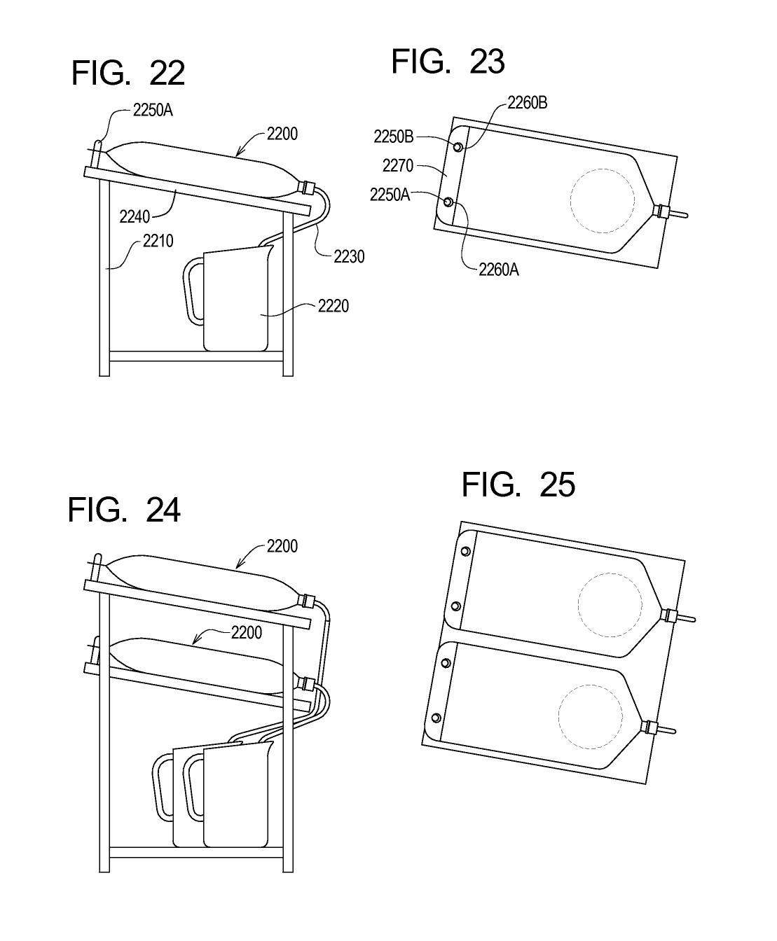

FIG. 22 is a side view of an exemplary arrangement for producing large volumes of extract using a cold brew system 2200. The arrangement includes a rack 2210 and a container 2220 for receiving cold brewed extract from the cold brew system 2200 via a hose 2230. The rack 2210 includes a shelf 2240 having one or more pegs 2250A, 2250B associated therewith. As shown in FIG. 23, the pegs 2250A, 2250B engage holes 2260A, 2260B formed in a tab 2270 of the cold brew system 2200.

FIG. 24 is a side view of another exemplary arrangement for producing large volumes of extract. The arrangement of FIG. 24 is similar to that shown in FIG. 22, except that it uses a plurality of cold brew systems 2200 on a single rack, it uses a multi-shelved rack, it uses a plurality of hoses and it uses a plurality of containers for receiving cold brewed extract. FIG. 25 is a top view of the arrangement shown in FIG. 23.

Each cold brew system 2200 is designed to hold large volumes of brewable ingredients and, therefore, is designed to be filled with large volumes of liquid. Although not shown, each cold brew system 2200 may include handles, so as to assist attendants in lifting same onto the rack 2240.

In one embodiment, a cold brew system 2200 is placed on a rack 2240 prior to being filled with a liquid. In one embodiment, at least two openings are provided in the cold brew system, wherein one opening is used to fill the cold brew system with liquid and wherein the other opening is used to receive extract. In one embodiment, an liquid supply hose attaches to one opening and an extract hose connects to the other opening.

In one embodiment, one or more of the extract or liquid supply hoses is a quick connect hose, which are easy to attach and detach. In one embodiment, the quick connect hose opens a valve upon connection, thereby not requiring a separate valve to be actuated.

In one embodiment, at least one of the liquid supply hoses has a valve therein. In one embodiment, upon connecting the liquid supply hose to the cold brew system, the valve is opened and liquid is able to flow into the cold brew system. In one embodiment, upon disconnecting the liquid supply hose from the cold brew system, the valve is closed.

In one embodiment, a hand-actuated valve is provided for one or more of the liquid supply hoses or extract hoses. In one embodiment, an electronically actuated valve is provided for one or more of the liquid supply hoses or extract hoses.

In one embodiment, instead of each extract hose leading to a separate container (as in FIG. 24), multiple extract hoses may lead to a single container. In one embodiment, a central container is provided, which accumulates extract from a plurality of cold brew systems. In one embodiment, multiple hoses lead to a main hose, which then leads to a central container. In one embodiment, one or more of the containers are air-tight.

In one embodiment, hooks are provided on the racks, so as to hold (e.g., hang) one or more liquid supply hoses, or one or more extract hoses, when not in use. In one embodiment, the racks include wheels, so as to assist in their transport (e.g., in the case of a remote event). In one embodiment, the wheels include wheel locks, so as to prevent movement of the racks (e.g., when they have reached their destination or when they are being transported, for example, in a truck).

In one embodiment, one or more of the shelves of the rack may be raised or lowered, so as to more easily place cold brew systems thereon. In one embodiment, one or more of the shelves may be locked into place.

By virtue of the description provided herein, one can recognize that the various embodiments of the cold brew system have a number of advantages. For example, at least one embodiment of the cold brew system is a completely self-contained unit, which includes everything needed to produce coffee extract, except water. Accordingly, there is no requirement for a user to handle brewable ingredients in order to produce extract. Furthermore, a user can produce a relatively large amount of extract without handling any brewable ingredients. There is no need for a consumer to purchase and grind coffee separately. There is no complicated measuring or brewing procedure to follow, as the system (in one embodiment) only requires a user to remove a cap, add water until the brewing bag is full, wait 8-24 hours, remove the cap and dispense extract. There is no requirement for parts to be assembled, replaced, cleaned and/or stored. In addition, the cold brew system is easily, safely and conveniently portable in its brewing or non-brewing state.

The fact that embodiments of the cold brew system include a brewing bag configuration is also advantageous. Specifically, such a configuration permits vacuum sealing of brewable ingredients, which allows the brewable ingredients to maintain their freshness and to have an increased shelf life. Furthermore, shipping, storage and shelf/display volumes are reduced relative to other cold brew systems. Moreover, no additional packaging is required, since the brewing bag may also act as the product's retail packaging.

The cold brew system is easily disposable and, in certain configurations, may be recyclable or compostable. In one embodiment, indicia is provided on the outside of the brewing bag 110 to indicate where the brewing bag 110 should be cut in order to dispose of the soaked brewable ingredients contained therein (in a relatively non-messy fashion), which are compostable. In one embodiment, the only plastic portions of the cold brew system may be the gusset, pour spout, check valve and cap, which may be recycled after the cold brew system has been disassembled.

In one embodiment, the brewing bag 110 may be made of a biodegradable material. For example, in one embodiment, the brewing bag 110 may be made of PLA film.

In one embodiment, no filter bag or filter is provided in the brewing bag. Instead, premeasured brewable ingredients are placed in a brewing bag. A cap is removed from a spout in the brewing bag and a liquid is used to fill the brewing bag. Next, the cap is replaced and the brewable ingredients and liquid are allowed to steep for 8-24 hours. Then, the cap is removed and extract (along with some of the soaked brewable ingredients) is poured out of the brewing bag into a container that may include a filter.

Several embodiments of the invention have been described. It should be understood that the concepts described in connection with one embodiment of the invention may be combined with the concepts described in connection with another embodiment (or other embodiments) of the invention.

1. A cold brew apparatus comprising:
a flexible brewing bag having an opening therein;
premeasured brewable ingredients in the brewing bag, wherein the opening in the brewing bag may be uncovered to allow a liquid to be added to the brewable ingredients and wherein the opening in the brewing bag may be covered after the liquid has been added.

2. The cold brew apparatus of claim 1, wherein a cap is provided to cover and uncover the opening.

3. The cold brew apparatus of claim 2, wherein the cap includes a check valve.

4. The cold brew apparatus of claim 1, wherein a check valve is attached to the brewing bag.

5. The cold brew apparatus of claim 1, wherein the opening is in a rigid spout.

6. The cold brew apparatus of claim 1, wherein an extract is created after the brewable ingredients and liquid have been allowed to steep for a period of time and wherein the opening is uncovered to pour the extract out of the brewing bag.

7. The cold brew apparatus of claim 1, further including a filter that has a surface area that is greater than three times the surface area of the opening.

8. The cold brew apparatus of claim 1, further including a filter that has an orientation relative to the opening that changes as the bag is rotated.

9. The cold brew apparatus of claim 1, wherein the brewing bag further includes a second opening in a drain valve, which may be selectively opened and closed.

10. A cold brew apparatus comprising:
a brewing bag; and,
a filter bag having brewable ingredients therein, wherein the filter bag is located within the brewing bag.

11. The cold brew apparatus of claim 10, wherein the filter bag is unattached to the brewing bag.

12. The cold brew apparatus of claim 10, wherein the filter bag is attached to the brewing bag, but is movable relative the brewing bag.

13. The cold brew apparatus of claim 12, wherein the filter bag is moveable relative to the brewing bag in at least two dimensions.

14. The cold brew apparatus of claim 1, wherein the brewing bag has a surface area and the filter bag has a surface area, and wherein the surface area of the filter bag is at least one-half the surface area of the brewing bag.

15. The cold brew apparatus of claim 14, wherein the surface area of the filter bag is approximately equal to the surface area of the brewing bag.

16. The cold brew apparatus of claim 10, wherein the brewing bag has a plurality of filter bags located therein and wherein the plurality of filter bags have brewable ingredients therein.

17. The cold brew apparatus of claim 16, wherein the plurality of filter bags have a combined surface area and the brewing bag has a surface area, and wherein the combined surface area of the plurality of filter bags is greater than the surface area of the brewing bag.

18. The cold brew apparatus of claim 10, wherein the brewing bag is made of a non-porous material.

19. The cold brew apparatus of claim 18, wherein the brewing bag includes an opening and a corresponding cap.

20. The cold brew apparatus of claim 10, wherein a liquid is poured through the opening.

21. The cold brew apparatus of claim 20, wherein an extract is poured through the opening after the liquid and brewable ingredients have been left to steep for a period of time.

22. The cold brew apparatus of claim 21, wherein the cap is placed over the opening after the liquid has been poured through the opening.

23. The cold brew apparatus of claim 10, wherein the brewing bag includes a plurality of openings.

24. The cold brew apparatus of claim 23, wherein a liquid is poured through one of the plurality of openings into the brewing bag in order to soak the brewable ingredients and wherein an extract is poured out of the brewing bag through a different one of the plurality of openings after the liquid and brewable ingredients have been left to steep for a period of time.

25. The cold brew apparatus of claim 10, wherein a consumer is not required to measure brewable ingredients in order to produce an extract.

26. The cold brew apparatus of claim 10, wherein the filter bag has an interior and a consumer is not intended to have access to the interior of the filter bag in order to produce an extract.

27. The cold brew apparatus of claim 10, wherein nothing besides water is required to be added to produce an extract.

28. The cold brew apparatus of claim 27, wherein the extract is emptied into a container.

29. The cold brew apparatus of claim 10, wherein a volume of air is removed from the brewing bag.

30. The cold brew apparatus of claim 29, wherein the brewing bag is made of a non-porous material, wherein the brewing bag includes an opening and wherein the opening is sealed by a removable seal after removing the volume of air from the brewing bag.

31. The cold brew apparatus of claim 30, wherein a cap is placed over the removable seal.

32. The cold brew apparatus of claim 10, wherein the brewing bag, the filter bag and the brewable extract are disposable.

33. The cold brew apparatus of claim 10, wherein the brewing bag, the filter bag and the brewable extract are recyclable.

34. The cold brew apparatus of claim 10, wherein the brewing bag, the filter bag and the brewable extract are compostable.

35. The cold brew apparatus of claim 10, wherein the brewing bag acts a retail package and includes appropriate indicia thereon.

36. The cold brew apparatus of claim 10, wherein the brewing bag has a handle.

37. The cold brew apparatus of claim 10, wherein the brewing bag is non-porous, wherein the brewing bag includes an opening and wherein a filter retaining member is provided to provide clearance between the filter bag and the opening.

38. The cold brew apparatus of claim 37, wherein extract flows through the opening at a greater flow rate when the filter retaining member is present as opposed to when the filter retaining member is not present.

39. The cold brew apparatus of claim 38, wherein the flow rate is further increased by squeezing the brewing bag.

40. The cold brew apparatus of claim 37, wherein the filter retaining member is formed by attaching a front of the brewing bag to a back of the brewing bag.

41. The cold brew apparatus of claim 40, wherein the brewing bag is made of biaxially-oriented polyethylene terephthalate.

42. The cold brew apparatus of claim 10, wherein the brewing bag includes a one-way valve, which permits gases to be released out of the brewing bag.

43. The cold brew apparatus of claim 10, wherein a cap that covers a spout attached to the brewing bag includes a one-way valve, which permits gases to be released out of the brewing bag.

44. The cold brew apparatus of claim 10, wherein the brewing bag is sized to receive a ratio of nine cups of water for each pound of brewable ingredients, such that when the brewing bag is filled upon receiving the appropriate amount of water associated with the brewable ingredients contained therein.

45. The cold brew apparatus of claim 44, wherein the brewing bag is scalable, as is the amount of brewable ingredients therein.

46. The cold brew apparatus of claim 10, further including a rigid cover in which the brewing bag is located.

47. The cold brew apparatus of claim 10, wherein the brewing bag includes a valve, which is provided to dispense extract directly from the brewing bag.

48. The cold brew apparatus of claim 10, wherein the filter bag is made of a polypropylene mesh.

49. The cold brew apparatus of claim 10, wherein the filter bag is made of a nylon mesh.

50. The cold brew apparatus of claim 10, wherein the filter bag is made of heat sealable paper.

51. The cold brew apparatus of claim 10, wherein the filter bag is made of natural fibers.

52. The cold brew apparatus of claim 10, wherein the brewing bag has a transparent or semi-transparent window therein.

53. The cold brew apparatus of claim 10, wherein the brewing bag includes a gusset.

54. The cold brew apparatus of claim 20, wherein the opening is in a spout, which is set an angle of 45 degrees relative to vertical.

55. The cold brew apparatus of claim 20, wherein the opening is in a spout, which is set a vertical angle.

56. A method of cold brewing coffee comprising:
providing a flexible brewing bag having an opening therein;
providing premeasured brewable ingredients in the brewing bag;
adding water to the brewing bag through the opening;
allowing the brewable ingredients and water to steep for a period of time to create an extract;
pouring the extract through the opening in the brewing bag;
increasing the flow rate through the opening by squeezing the brewing bag.

57. The method of claim 56 further comprising:
providing a cap for the opening;
covering the opening with the cap after the water has been added to the brewing bag;
removing the cap to uncover the opening after the period of time has passed.

58. The method of claim 56 further comprising:
providing a filter bag that is located within the brewing bag and in which the premeasured brewable ingredients reside.
